(19) United States
(12) Patent Application Publication
(10) Pub. No.: US 2010/0216935 A1
(43) Pub. Date: Aug. 26, 2010

(54) PREPARATION OF SULFIDOSILANES

(76) Inventors: Lisa Marie BOSWELL, Auburn, MI (US); Michael Wolfgang Backer, Barry (GB); Shawn Keith Mealey, Midland, MI (US); Laurence Stelandre, Marcq En Baroeul (FR)

Correspondence Address: DOW CORNING CORPORATION CO1232, 2200 W. SALZBURG ROAD, P.O. BOX 994, MIDLAND, MI, 48686-0994, US

(21) Appl. No.: 12/774,090

(22) Filed: May 5, 2010

Related U.S. Application Data
(62) Division of application No. 12/092,717, filed on May 6, 2008.
(60) Provisional application No. 60/737,236, filed on Nov. 16, 2005.

(51) Int. Cl. C07F 7/08; C08L 101/00

(52) U.S. Cl. 524/543; 556/427

(57) ABSTRACT

A process for the preparation of a sulfidosilane comprising reacting an aqueous phase comprising a sulfide compound, which is a polysulfide of the formula M₂Sₓ and/or a mixture of sulfur with a hydrosulfide of the formula MHS or a sulfide of the formula M₂Sₙ, where M represents ammonium or an alkali metal, x is defined as above and n has an average value of 1 to 10, with a silane mixture of an alkoxydialkylhaloalkylsilane of the formula (R′O)R₂Si-A-Z and a hydroxydialkylhaloalkylsilane of the formula (HO)R₂Si-A-Z, where each R is selected from alkyl or aryl groups having 1 to 18 carbon atoms, each A independently represents the same or different divalent organic group having 1 to 18 carbon atoms, R′ represents an alkyl group having 1 to 8 carbon atoms and Z represents a halogen selected from chlorine, bromine and iodine.

### CROSS-REFERENCE TO RELATED APPLICATIONS

This application is a divisional of U.S. application Ser. No. 12/092,717, still pending, which is the National Stage of International Application No. PCT/US06/041176, filed on Oct. 16, 2006, which claims the benefit of Provisional Patent Application No. 60/737,236, filed on Nov. 16, 2005. U.S. application Ser. No. 12/092,717, PCT Application No. PCT/US06/041176, and U.S. Provisional Application No. 60/737,236 are hereby incorporated by reference in their entirety to provide continuity of disclosure.

### FIELD OF THE INVENTION

This invention relates to a novel method for the preparation of sulfidosilanes useful as coupling agents for filled elastomer compositions comprising reacting an aqueous phase comprising a sulfide compound with a silane mixture of an alkoxydialkylhaloalkylsilane and a hydroxydialkylhaloalkylsilane.

### BACKGROUND TO THE INVENTION

Sulfidosilanes of the general formula (R¹R²R³Si—R⁴₂—)ₓ, with R¹, R² and R³ independently being various alkyl and alkoxy sub stituents, and R⁴ being an alkylene or alkylidene spacer, are known as coupling agents in the elastomer industry for reinforcement of synthetic rubbers with inorganic fillers. The coupling agents promote bonding of the elastomer and the reinforcing inorganic filler, thus enhancing the physical properties of the filled elastomer for use, for example, in the tire industry. The sulfidosilane compounds most widely used as coupling agents have been bis(triethoxysilylpropyl)-tetrasulfane described in U.S. Pat. No. 3,978,103 and bis(triethoxysilylpropyl)-disulfane described in U.S. Pat. No. 5,468,893 and EP-A-723362.

The sulfidosilanes containing ethoxy groups may emit some ethanol on curing. In recent years, a request for lower VOC (volatile organic chemicals)-emitting compounds has been seen in industry due to safety and environmental concerns. Solutions to this problem which have been proposed include sulfidosilane coupling agents containing fewer alkoxy groups such as bis(dimethylethoxysilylpropyl)oligosulfanes described in EP-A-1043357 and bis(dimethylhydroxysilylpropyl)polysulfanes disclosed in WO-02/30939 and U.S. Pat. No. 6,774,255.

The sulfidosilanes of the general formula (R¹R²R³Si—R⁴)₂—Sₓ are normally prepared, under anhydrous or aqueous phase conditions, by nucleophilic substitution reaction (sulfurization) of the chlorine atom of the respective chloropropylsilane Cl—R⁴—SiR¹R²R³ with polysulfide di-anions generated in situ by reaction of an alkali metal sulfide or hydrosulfide with sulfur. The bis(dimethylhydroxysilylpropyl)polysulfanes disclosed in WO-02/30939 are prepared by sulfurization of the corresponding chloropropyldimethylsilanol, which itself is generated by hydrolysis of either chloropropyldimethylchlorosilane or chloropropyldimethylethoxysilane.

U.S. Pat. No. 6,384,255, U.S. Pat. No. 6,384,256 and U.S. Pat. No. 6,448,246 describe processes for the production of sulfidosilanes by phase transfer catalysis techniques. The processes of U.S. Pat. No. 6,384,255 and U.S. Pat. No. 6,448,246 involve reacting a phase transfer catalyst with the aqueous phase components of the process (polysulfide di-anions and/or an alkali metal sulfide or hydrosulfide with sulfur) to create an intermediate reaction product, which is then reacted with a silane compound. In the process of U.S. Pat. No. 6,384,256 the silane compound is reacted in the presence of a phase transfer catalyst with a polysulfide mixture formed by reacting an alkali metal hydroxide with an alkali metal sulfide or hydrosulfide and sulfur.

### SUMMARY OF THE INVENTION

According to one aspect, the present invention provides a sulfidosilane of the formula

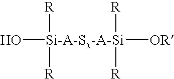

wherein each R, which may be the same or different, represents an alkyl or aryl group having 1 to 18 carbon atoms, R′ represents an alkyl, hydroxyalkyl, or alkoxyalkyl group having 1 to 8 carbon atoms, each A independently represents the same or different divalent organic group having 1 to 18 carbon atoms and x has a value in the range 2 to 10. Preferably x is in the range 2 to 5. The invention includes coupling agent compositions containing such a sulfidosilane. Furthermore the invention includes a sulfidosilane composition comprising at least two sulphidosilanes of the above formula. In such a sulfidosilane composition, x preferably has an average value in the range 2 to 5.

Coupling agent compositions according to the invention include those comprising sulfidosilanes of the formula:

Y′Y₂Si-A-Sₓ-A-SiY₂Y′

wherein each Y is selected from alkyl or aryl groups having 1 to 18 carbon atoms and alkoxy groups having 1 to 8 carbon atoms, each Y′ is selected from hydroxyl and alkoxy, hydroxyalkoxy, or alkoxyalkoxy groups having 1 to 8 carbon atoms, each A independently represents the same or different divalent organic group having 1 to 18 carbon atoms and x has an average value of 2 to 5, wherein the average number of alkoxy, hydroxyalkoxy, or alkoxyalkoxy groups per sulfidosilane molecule is less than 2 and at least part of the sulfidosilane in the composition is of the formula

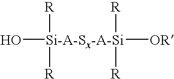

as defined above.

A process according to the invention for the preparation of a coupling agent composition comprising sulfidosilanes of the formula

Y′R₂Si-A-Sₓ-A-SiR₂Y′

wherein R is selected from alkyl or aryl groups having 1 to 18 carbon atoms, each Y′ is selected from hydroxyl and alkoxy, hydroxyalkoxy, or alkoxyalkoxy groups having 1 to 8 carbon atoms, each A independently represents the same or different divalent organic group having 1 to 18 carbon atoms and x has an average value of 2 to 5, comprises reacting an aqueous phase comprising a sulfide compound, which is a polysulfide of the formula M₂Sₓ and/or a mixture of sulfur with a hydrosulfide of the formula MHS or a sulfide of the formula M₂Sₙ, where M represents ammonium or an alkali metal, x is defined as above and n has an average value of 1 to 5, with an alkoxydialkylhaloalkylsilane of the formula (R′O)R₂Si-A-Z, where R and A are defined as above, R′ represents an alkyl, hydroxyalkyl, or alkoxyalkyl group having 1 to 8 carbon atoms and Z represents a halogen selected from chlorine, bromine and iodine,
In the presence of a phase transfer catalyst under conditions such that partial hydrolysis of alkoxysilane groups takes place to produce a coupling agent product in which at least part of the sulfidosilane in the product composition is of the formula

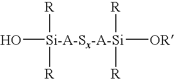

as defined above.

A sulfidosilane of the formula

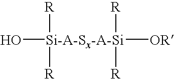

can be prepared by preparing a coupling agent composition as described above, stripping the composition of volatile components under vacuum and separating the sulfidosilane of formula

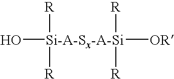

for example by liquid chromatography or fractional distillation. The invention also includes alternative processes for the preparation of a sulfidosilane of the formula

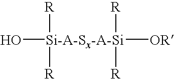

The invention also includes an elastomer composition comprising at least one diene elastomer, at least one reinforcing filler and a sulfidosilane coupling agent composition, characterized in that the sulfidosilane coupling agent composition comprises a sulfidosilane of the formula

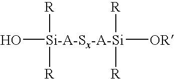

as defined above.

### DETAILED DESCRIPTION OF THE INVENTION

In the sulfidosilane of formula

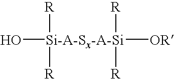

each R preferably represents a methyl or ethyl group and most preferably all the groups R are methyl. The group R′ is preferably an alkyl group having 1-4 carbon atoms as methyl, ethyl, propyl or isopropyl, or butyl group, most preferably ethyl, but R′ can alternatively be an octyl group or a hydroxyalkyl group such as 2-hydroxyethyl, 3-hydroxypropyl, or 3-hydroxy-2-methylpropyl or an alkoxyalkyl group such as ethoxyethyl. Each A preferably represents an alkylene group having 1 to 4 carbon atoms such as a methylene, ethylene, propylene, butylene or iso-butylene group, most preferably a —(CH₂)₃— or —CH₂CH(CH₃)CH₂— group. Particularly preferred compounds are those in which all groups R are methyl, R′ is ethyl, each A represents a —(CH₂)₃— group and x has a value of 2 or 4. Particularly preferred sulfidosilane compositions are those in which all groups R are methyl, R′ is ethyl, each A represents a —(CH₂)₃— group and x has an average value in the range of 2 to 4.

In the process of the invention for the preparation of a coupling agent composition comprising sulfidosilanes of the formula

Y′R₂Si-A-Sₓ-A-SiR₂Y′,

an alkoxydialkylhaloalkylsilane is reacted in the presence of a phase transfer catalyst with an aqueous phase comprising a sulfide compound, which is a polysulfide of the formula M₂Sₓ and/or a mixture of sulfur with a hydrosulfide of the formula MHS or a sulfide of the formula M₂Sₙ, where M represents ammonium or an alkali metal, x is defined as above and n has an average value of 1 to 10. In the sulfide compounds of the formula M₂Sₓ, M₂Sₙ or MHS, where M represents an alkali metal or ammonium group, representative alkali metals include lithium, potassium, sodium, rubidium, or cesium. Preferably M is sodium. Examples of the MHS compound include NaHS, KHS, and NH₄HS. When the sulfide compound is an MHS compound, NaHS is preferred. Specific examples of the NaHS compound include NaHS flakes (containing 71.5-74.5% NaHS) and NaHS liquors (containing 45-60% NaHS) from PPG of Pittsburgh, Pa. Specific examples of compounds of M₂Sₙ include Na₂S, K₂S, Cs₂S, (NH₄)₂S, Na₂S₂, Na₂S₃, Na₂S₄, Na₂S₆, K₂₅₂, K₂₅₃, K₂₅₄, K₂₅₆, and (NH₄)₂S₂. Preferably the sulfide compound is Na₂S. A particular preferred sulfide compound is sodium sulfide flakes (containing 60-63% Na₂S) from PPG of Pittsburgh, Pa.

In one preferred embodiment of the invention, the sulfide compound is a mixture of a polysulfide of the formula M₂Sₓ and sulfur with a hydrosulfide of the formula MHS or a sulfide of the formula M₂S, said mixture being formed in a preliminary reaction step involving the formation of a mixture of polysulfide compounds M₂Sₓ by reacting an alkali metal hydroxide compound, a sulfide compound and sulfur in water.

The alkali metal hydroxide compounds that can be used in the preliminary reaction step are the hydroxide compounds of the Group I alkali metals, such as lithium hydroxide, sodium hydroxide, potassium hydroxide, rubidium hydroxide, and cesium hydroxide. The preferred metal hydroxide compound is sodium hydroxide.

Sulfide compounds of the formula M₂Sₙ or MHS are used in the preliminary reaction step, where M and n are defined as above. Preferred examples are NaHS flakes, NaHS liquors and sodium sulfide flakes as described above.

The sulfur used in the first step of the present invention is elemental sulfur. The type and form are not critical and can include those commonly used. An example of a suitable sulfur material is 100 mesh refined sulfur powder from Aldrich Chemical of Milwaukee Wis.

The proportions of alkali metal hydroxide compound, alkali metal hydrosulfide compound and sulfur used in the preliminary reaction step can vary. Preferably the molar ratio of S/HS⁻ ranges from 0.1 to 10. The molar ratio of S/HS⁻ compound can be used to affect the final product distribution, that is the average value of x in the formula Y′R2S-A-Sₓ-A-SiR₂Y′. When the average value of x is desired to be about 4, for example in the range 3.25 to 4.25, the preferred range for the molar ratio of S/HS⁻ compound is from 2.7 to 3.2. When the average value of x is desired to be 2 or about 2, for example 2.0 to 2.3, the preferred range for the molar ratio of sulfur to hydrosulfide compound is from 0.8 to 1.2.

The amount of alkali metal hydroxide used in the first reaction step can be from 0.1 to 10 moles per mole of sulfide compound used. Preferably the molar ratio of alkali metal hydroxide to sulfide compound is from 0.8 to 1.2, and most preferably from 0.95 to 1.05.

The amount of water used in the first reaction step can vary. Generally, a sufficient amount of water is added to prevent precipitation of dialkali metal sulfides that are formed. Optional ingredients can also be added to the water to enhance the reaction. For example, sodium chloride or other brine salts can be added.

The preliminary reaction step involving mixing an alkali metal hydroxide compound, an alkali metal hydrogen sulfide compound, sulfur and water together in a reaction vessel can be conducted at a variety of temperatures, but generally in the range of 20 to 100° C. Preferably, the reaction is conducted at a temperature ranging from 50 to 90° C. Generally, this first reaction step can be conducted at various pressures, but preferably is conducted at atmospheric pressure. The time needed for the reaction of the first step to occur is not critical, but generally ranges from 5 to 300 minutes.

In the process of the invention, the polysulfide M₂Sₓ, which may be formed by a preliminary reaction step as described above, and/or a mixture of sulfur with a hydrosulfide of the formula MHS or a sulfide of the formula M₂Sₙ, is preferably mixed with the phase transfer catalyst before contacting the alkoxydialkylhaloalkylsilane. The phase transfer catalyst can alternatively be mixed with the alkoxydialkylhaloalkylsilane or added to a mixture of polysulfide and alkoxydialkylhaloalkylsilane, but this is less preferred.

The phase transfer catalyst is preferably a quaternary onium cation compound, particularly a quaternary ammonium cation salt. Preferred examples of the quaternary onium cations as phase transfer catalysts are described in U.S. Pat. No. 5,405,985, which is hereby incorporated by reference. Preferably, the quaternary ammonium salt is a tetraalkyl ammonium salt containing a total of 10 to 30 carbon atoms in its four alkyl groups. Particularly preferred phase transfer catalysts are tetrabutyl ammonium bromide or tetrabutyl ammonium chloride, for example tetrabutyl ammonium bromide (99%) from Aldrich Chemical of Milwaukee, Wis.

If a preliminary reaction step with alkali metal hydroxide is not used, it may be preferred to react sulfur with a sulfide of the formula M₂Sₙ in the presence of the phase transfer catalyst and water before contacting the alkoxydialkylhaloalkylsilane. This reaction can be conducted at a variety of temperatures, but generally in the range of 40-100° C., preferably 65-95° C. The time for the reaction can for example be from 5 to 300 minutes. If the reaction with sulfur is carried out in the presence of the phase transfer catalyst without an alkali metal hydroxide, a buffer such as sodium or potassium carbonate is preferably present as described in U.S. Pat. No. 6,448,426. Sulfur can alternatively be reacted with a hydrosulfide of the formula MHS in the presence of the phase transfer catalyst, but hydrogen sulphide may be generated as a by-product

If the alkoxydialkylhaloalkylsilane is reacted with sulfur and a sulfide compound in the presence of the phase transfer catalyst without preliminary reaction of the sulfur and sulfur compound, MHS compounds are generally used preferentially in the presence of a buffer when the average value of x in the desired sulfidosilanes Y′R2Si-A-SₓA-SiR₂Y′ is desired to be 2. M₂Sₙ compounds are used preferentially when the average value of n in the desired sulfidosilanes Y′R₂Si-A-Sₓ-A-SiR₂Y′ is desired to be 4.

The amount of the phase transfer catalyst used in the process of the invention can vary. Preferably the amount of phase transfer catalyst is from 0.1 to 10 weight %, and most preferably from 0.5 to 2 weight %, based on the amount of alkoxydialkylhaloalkylsilane used.

The total amount of water present in the process of the invention is generally 1 to 100% based on the weight of alkoxydialkylhaloalkylsilane used. Water can be added directly, or indirectly, as some water may already be present in other starting materials. The total amount of water present, that is all water added either directly or indirectly, is preferably in a range of 2.5 to 70 weight %, more preferably 20 to 50 weight % of water used based on the alkoxydialkylhaloalkylsilane. In general, increasing the proportion of water present during reaction with the alkoxydialkylhaloalkylsilane will tend to increase the degree of hydrolysis of the alkoxy groups R′ to hydroxyl groups and thus increase the proportion of sulfidosilane of the formula

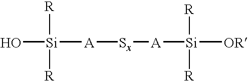

in the product composition.

The alkoxydialkylhaloalkylsilane is generally of the formula (R′O)R2Si-A-Z, wherein each R, which may be the same or different, represents an alkyl or aryl group having 1 to 18 carbon atoms, R′ represents an alkyl, hydroxyalkyl, or alkylalkoxy group having 1 to 8 carbon atoms, each A independently represents a divalent organic group having 1 to 18 carbon atoms and Z represents a halogen selected from chlorine, bromine and iodine. The haloalkyl group is preferably chloroalkyl. Preferred alkoxydialkylhaloalkylsilanes are particularly chloropropyldimethylethoxysilane and also chloropropyldimethylmethoxysilane. The reaction between the alkoxydialkylhaloalkylsilane and the sulfide compound is carried out under conditions such that partial hydrolysis of alkoxysilane groups takes place. The reaction can be conducted at a variety of temperatures, but generally temperatures in the range of 40-110° C., particularly 65-100° C., are preferred. The time for the reaction can for example be from 5 to 600 minutes. Agitation of the alkoxydialkylhaloalkylsilane and the aqueous phase containing the sulfide compound during the reaction in the presence of the phase transfer catalyst tends to promote some hydrolysis of alkoxysilane groups. Vigorous stirring of the reaction is thus preferred, and the reaction is preferably carried out in a reactor that is only partially filled. This tends to provide a very high surface area between the aqueous and the organic (alkoxydialkylhaloalkylsilane) phase. This results in a good contact of the alkoxysilane with water to induce partial hydrolysis. The extent of partial hydrolysis is preferably such as to produce a coupling agent product in which at least 0.1% by weight, more preferably at least 5 or 10% by weight, of the sulfidosilane in the product composition is of the formula

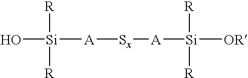

as defined above. Most preferably at least 20%, for example 20 to 35%, of the sulfidosilane product is of the formula

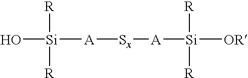

The sulfidosilane composition may contain a very minor amount of a bis(silanol)

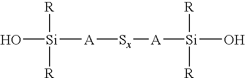

formed by complete hydrolysis, or of a dimer or oligomer of the formula

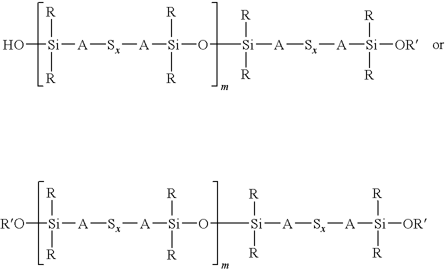

where m is at least 1, formed by condensation of silanol groups.

The sulfidosilane composition thus prepared, after stripping the composition of volatile components, preferably under vacuum, is generally suitable for use as a coupling agent in elastomer compositions without further separation of the compounds of the formula

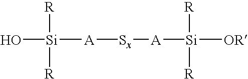

We have found that the sulfidosilane composition gives advantages as a coupling agent when it contains at leastl0% of such compounds, or even when it contains only 5% or 0.1% of such compounds. If desired, the compound of formula

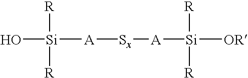

can be separated by chromatography, particularly liquid chromatography such as high pressure liquid chromatography, or by fractional distillation.

In an alternative process for the preparation of a compound of the formula

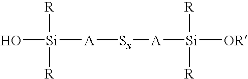

an aqueous phase comprising a sulfide compound, which is a polysulfide of the formula M₂Sₓ and/or a mixture of sulfur with a hydrosulfide of the formula MHS or a sulfide of the formula M₂Sₙ, where M represents ammonium or an alkali metal, x is defined as above and n has an average value of 1 to 10, is reacted with a silane mixture of an alkoxydialkylhaloalkylsilane of the formula (R′O)R₂Si-A-Z and a hydroxydialkylhaloalkylsilane of the formula (HO)R₂Si-A-Z, where each R is selected from alkyl or aryl groups having 1 to 18 carbon atoms, each A independently represents the same or different divalent organic group having 1 to 18 carbon atoms, R′ represents an alkyl, hydroxyalkyl, or alkoxyalkyl group having 1 to 8 carbon atoms and Z represents a halogen selected from chlorine, bromine and iodine.

In general the sulfide compound can be any of those described above. For example a mixture of a polysulfide of the formula M₂Sₓ and sulfur with a hydrosulfide of the formula MHS or a sulfide of the formula M₂S can be formed in a preliminary reaction step of reacting an alkali metal hydroxide compound, a sulfide compound and sulfur in water. The temperatures and times of reaction are generally as described above.

The alkoxydialkylhaloalkylsilane and hydroxydialkylhaloalkylsilane can for example be present at a molar ratio of 5:1 to 1:5 in the silane mixture that is reacted with the sulfide compound, preferably a molar ratio of 1:2 to 2:1. The product of the reaction is generally a mixture of the sulfidosilane of the formula

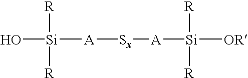

with a bis(alkoxydialkylsilyl)sulfidosilane and/or a bis(hydroxydialkylsilyl)sulfidosilane, as shown in the reaction scheme 1 below

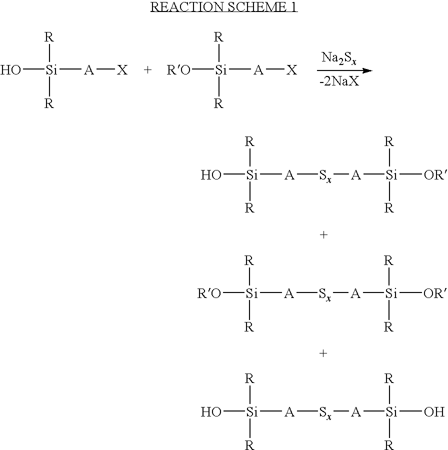

The aqueous phase comprising a sulfide compound and the silane mixture are preferably reacted in the presence of a phase transfer catalyst. The phase transfer catalyst is preferably a quaternary ammonium salt as described above, for example tetrabutyl ammonium bromide or tetrabutyl ammonium chloride. The total amount of water present during reaction with the silane mixture is preferably 2.5 to 50% by weight, most preferably no more than 35% by weight as there is no need to hydrolyze the Si-alkoxy groups during the reaction.

In an alternative process for the preparation of a sulfidosilane of the formula

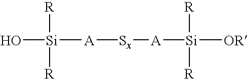

a sulfidosilane of the formula

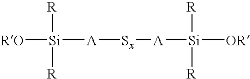

wherein each R, which may be the same or different, represents an alkyl or aryl group having 1 to 18 carbon atoms, each R′ represents an alkyl, hydroxyalkyl, or alkoxyalkyl group having 1 to 8 carbon atoms, each A independently represents the same or different divalent organic group having 1 to 18 carbon atoms and x has an average value of 2 to 5, is hydrolyzed, preferably under alkaline conditions. The hydrolysis can for example be carried out in the presence of a solution of an alkali metal hydroxide such as sodium hydroxide, preferably a solution in a mixture of water and a water miscible organic solvent such as methanol. The reaction product can be neutralized with a buffer, for example a phosphate buffer such as an alkali metal dihydrogen phosphate, and extracted with an organic solvent such as an ether, as shown in reaction scheme 2 below

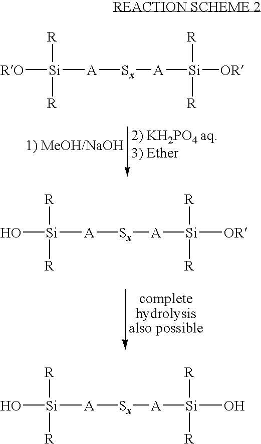

In a further alternative process for the preparation of a sulfidosilane of the formula

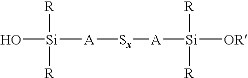

a bis(dialkylalkoxysilyl)sulfidosilane of the formula

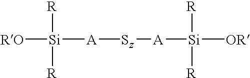

wherein each R, which may be the same or different, represents an alkyl or aryl group having 1 to 18 carbon atoms, each R′ represents an alkyl, hydroxyalkyl, or alkylalkoxy group having 1 to 8 carbon atoms, each A independently represents the same or different divalent organic group having 1 to 18 carbon atoms, and z has a value in the range 2 to 10, for example an average value in the range 4 to 10, is reacted with a hydroxydialkylmercaptosilane of the formula (HO)R₂Si-A-SH, where each R is selected from alkyl or aryl groups having 1 to 18 carbon atoms and A represents a divalent organic group having 1 to 18 carbon atoms. The reaction is preferably carried out in the presence of a base, most preferably a strong base such as an alkali metal alkoxide which can be dissolved in alcohol such as ethanol. This reaction involves nucleophilic attack by the S⁻ anion of the hydroxydialkylmercaptosilane on the polysulfide chain, resulting in cleavage of the polysulfide chain and bonding of the residue of the bis(dialkylalkoxysilyl)sulfidosilane with the anion of the hydroxydialkylmercaptosilane. This reaction normally results in a reduction of the average sulfur chain length. The preparation of such silane thiolate salt is described in H. Chunye et al., Kexue Tangbao 1988, 33 (10), 843 and such a nucleophilic reaction is described in U.S. Pat. No. 6,452,034 and in EP-A-1439183. Alternatively a bis(dialkylhydroxysilyl)sulfidosilane of the formula

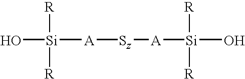

wherein each R, which may be the same or different, represents an alkyl or aryl group having 1 to 18 carbon atoms, each A independently represents the same or different divalent organic group having 1 to 18 carbon atoms and z has a value in the range 2 to 10, for example an average value in the range 4 to 10, can be reacted with an alkoxydialkylmercaptosilane of the formula (R′O)R₂Si-A-SH, where each R is selected from alkyl or aryl groups having 1 to 18 carbon atoms, R′ represents an alkyl, hydroxyalkyl, or alkoxyalkyl group having 1 to 8 carbon atoms, and A represents a divalent organic group having 1 to 18 carbon atoms, under the same reaction conditions. These two alternative processes are both set out in reaction scheme 3 below. The type of reaction involved in both processes set out in reaction scheme 3 normally results in a reduction in the average sulfur chain length if the starting chain length S_{z} is greater than 2, such that in reaction scheme 3 below x<z.

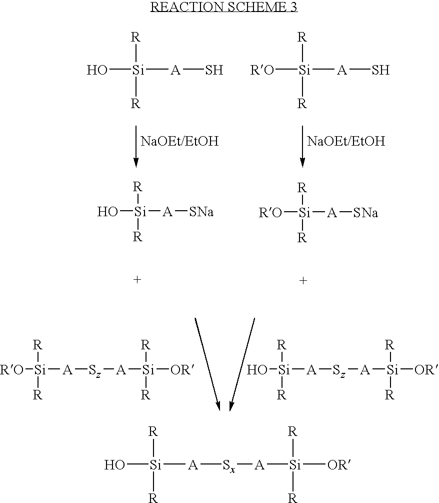

The product of any of the above reactions will in general be a mixture of the sulfidosilane of the formula

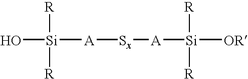

with a bis(dialkylalkoxysilyl)sulfidosilane and/or a bis(dialkylhydroxysilyl)sulfidosilane. Such a mixture can be used as a sulfidosilane coupling agent, or the compound of formula

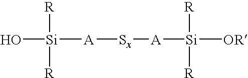

can be separated, for example by chromatography, particularly liquid chromatography such as high pressure liquid chromatography, or by fractional distillation.

The sulfidosilanes of the invention and/or the coupling agent compositions of the invention are suitable for use as coupling agents in the elastomer industry for reinforcement of synthetic rubbers with fillers. The invention thus includes an elastomer composition comprising at least one diene elastomer, at least one reinforcing filler and a sulfidosilane coupling agent composition, characterized in that the sulfidosilane coupling agent composition comprises a sulfidosilane of the formula

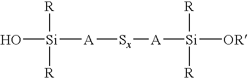

as defined above. The sulfidosilane of this formula preferably comprises at least 10% by weight of the sulfidosilane coupling agent composition.

The invention also includes the use of a coupling agent composition as defined above, comprising sulfidosilanes of the formula

Y′Y₂S-A-Sₓ-A-SiY₂Y′

wherein each Y is selected from alkyl or aryl groups having 1 to 18 carbon atoms and alkoxy groups having 1 to 8 carbon atoms, each Y′ is selected from hydroxyl and alkoxy, hydroxyalkoxy, or alkoxyalkoxy groups having 1 to 8 carbon atoms, each A independently represents the same or different divalent organic group having 1 to 18 carbon atoms and x has a value of 2-10 and an average value in the range 2 to 5, in which the average number of alkoxy groups per sulfidosilane molecule is less than 2 and at least 0.1% by weight of the sulfidosilane in the coupling agent composition is of the formula

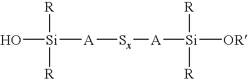

as defined above, in an elastomer composition comprising at least one diene elastomer and at least one reinforcing filler to promote bonding between the elastomer and the reinforcing filler.

The invention also includes a process for the preparation of an elastomer composition characterized in that at least one diene elastomer is thermomechanically mixed with at least one reinforcing filler, a curing agent for the elastomer and a sulfidosilane coupling agent composition and the resulting elastomer composition is cured under conditions for the elastomer, characterized in that the sulfidosilane coupling agent composition comprises a sulfidosilane of the formula

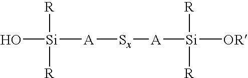

as defined above.

The sulfidosilane coupling agents of the invention promote bonding of the elastomer and the reinforcing filler, thus enhancing the physical properties of the filled elastomer for use, for example, in the tire industry.

The elastomer used in the tires, treads and elastomer compositions according to the invention is generally a diene elastomer, that is an elastomer resulting at least in part (i.e. a homopolymer or a copolymer) from diene monomers (monomers bearing two double carbon-carbon bonds, whether conjugated or not). Preferably the elastomer is an “essentially unsaturated” diene elastomer, that is a diene elastomer resulting at least in part from conjugated diene monomers, having a content of members or units of diene origin (conjugated dienes) which is greater than 15 mol %. More preferably it is a “highly unsaturated” diene elastomer having a content of units of diene origin (conjugated dienes) which is greater than 50%. Diene elastomers such as butyl rubbers or copolymers of dienes and of alpha-olefins of the ethylene-propylene diene monomer (EPDM) type, which may be described as “essentially saturated” diene elastomers having a low (less than 15%) content of units of diene origin, can alternatively be used.

The diene elastomer can for example be:—
(a) any homopolymer obtained by polymerization of a conjugated diene monomer having 4 to 12 carbon atoms;
(b) any copolymer obtained by copolymerization of one or more dienes conjugated together or with one or more vinyl aromatic compounds having 8 to 20 carbon atoms;
(c) a ternary copolymer obtained by copolymerization of ethylene, of an [alpha]-olefin having 3 to 6 carbon atoms with a non-conjugated diene monomer having 6 to 12 carbon atoms, such as, for example, the elastomers obtained from ethylene, from propylene with a non-conjugated diene monomer of the aforementioned type, such as in particular 1,4-hexadiene, ethylidene norbornene or dicyclopentadiene;
(d) a copolymer of isobutene and isoprene (butyl rubber), and also the halogenated, in particular chlorinated or brominated, versions of this type of copolymer.

Although the coupling agents of the present invention can be used in compositions based on any type of diene elastomer, the person skilled in the art of tires will understand that the coupling agent, when used in a tire tread, is used first and foremost with essentially unsaturated diene elastomers, in particular those of type (a) or (b) above.

Suitable conjugated dienes are, in particular, 1,3-butadiene, 2-methyl-1,3-butadiene, 2,3-di(C₁-C₅ alkyl)-1,3-butadienes such as, for instance, 2,3-dimethyl-1,3-butadiene, 2,3-diethyl-1,3-butadiene, 2-methyl-3-ethyl-1,3-butadiene, 2-methyl-3-isopropyl-1,3-butadiene, an aryl-1,3-butadiene, 1,3-pentadiene and 2,4-hexadiene. Suitable vinyl-aromatic compounds are, for example, styrene, ortho-, meta- and para-methylstyrene, the commercial mixture “vinyltoluene”, para-tert.-butylstyrene, methoxystyrenes, chlorostyrenes, vinylmesitylene, divinylbenzene and vinylnaphthalene.

The copolymers may contain between 99% and 20% by weight of diene units and between 1% and 80% by weight of vinyl aromatic units. The elastomers may have any microstructure, which is a function of the polymerization conditions used, in particular of the presence or absence of a modifying and/or randomizing agent and the quantities of modifying and/or randomizing agent used. The elastomers may for example be block, statistical, sequential or microsequential elastomers, and may be prepared in dispersion or in solution; they may be coupled and/or starred or alternatively functionalized with a coupling and/or starring or functionalizing agent.

Preferred are polybutadienes, and in particular those having a content of 1,2-units between 4% and 80%, or those having a content of cis-1,4 of more than 80%, polyisoprenes, butadiene-styrene copolymers, and in particular those having a styrene content of between 5% and 50% by weight and, more particularly, between 20% and 40%, a content of 1,2-bonds of the butadiene fraction of between 4% and 65%, and a content of trans-1,4 bonds of between 20% and 80%, butadiene-isoprene copolymers and in particular those having an isoprene content of between 5% and 90% by weight. In the case of butadiene-styrene-isoprene copolymers, those which are suitable are in particular those having a styrene content of between 5% and 50% by weight and, more particularly, between 10% and 40%, an isoprene content of between 15% and 60% by weight, and more particularly between 20% and 50%, a butadiene content of between 5% and 50% by weight, and more particularly between 20% and 40%, a content of 1,2-units of the butadiene fraction of between 4% and 85%, a content of trans-1,4 units of the butadiene fraction of between 6% and 80%, a content of 1,2-plus 3,4-units of the isoprene fraction of between 5% and 70%, and a content of trans-1,4 units of the isoprene fraction of between 10% and 50%.

The coupling agents of the invention are used in particular in elastomer compositions used for a tread for a tire, be it a new or a used tire (case of recapping).

In the case of a passenger car tire, the elastomer is for example a Styrene Butadiene rubber (SBR), for example an SBR prepared in emulsion (“ESBR”) or an SBR prepared in solution (“SSBR”), or an SBR/BR, SBR/NR (or SBR/IR), or alternatively BR/NR (or BR/IR), blend (mixture). In the case of an SBR elastomer, in particular an SBR having a styrene content of between 20% and 30% by weight, a content of vinyl bonds of the butadiene fraction of between 15% and 65%, and a content of trans-1,4 bonds of between 15% and 75% Such an SBR copolymer, preferably an SSBR, is possibly used in a mixture with a polybutadiene (BR) having preferably more than 90% cis-1,4 bonds.

In the case of a tire for a heavy vehicle, the elastomer is in particular an isoprene elastomer; that is an isoprene homopolymer or copolymer, in other words a diene elastomer selected from the group consisting of natural rubber (NR), synthetic polyisoprenes (1R), the various isoprene copolymers or a mixture of these elastomers. Of the isoprene copolymers, mention will be made in particular of isobutene-isoprene copolymers (butyl rubber-IIR), isoprene-styrene copolymers (SIR), isoprene-butadiene copolymers (BIR) or isoprene-butadiene-styrene copolymers (SBIR). This isoprene elastomer is preferably natural rubber or a synthetic cis-1,4 polyisoprene; of these synthetic polyisoprenes, preferably polyisoprenes having a content (mole %) of cis-1,4 bonds greater than 90%, more preferably still greater than 98%, are used. For such a tire for a heavy vehicle, the elastomer may also be constituted, in its entirety or in part, of another highly unsaturated elastomer such as, for example, an SBR elastomer.

When the elastomer composition is for use as a tire sidewall, the elastomer may comprise at least one essentially saturated diene elastomer, in particular at least one EPDM copolymer, which may for example be used alone or in a mixture with one or more of the highly unsaturated diene elastomers.

The elastomer can be an alkoxysilane-terminated or tin coupled solution polymerization prepared elastomer.

The alkoxysilane-terminated elastomers may be prepared, for example, by introduction of a chloro-alkoxysilane, chloro-alkylalkoxysilane or 3,3′-bis-(triethoxysilylpropyl)disulfide, into the polymerization system during the preparation of the elastomer, usually at or near the end of the polymerization.

Tin coupled elastomers may be prepared by introducing a tin coupling agent during the polymerization reaction, usually at or near the end of the polymerization.

Representative of tin coupled diene-based elastomers are, for example styrene/butadiene copolymers, isoprene/butadiene copolymers and styrene/isoprene/butadiene terpolymers. It is preferred that a major portion, preferably at least about 50 percent, and more generally in a range of about 60 to about 85 percent of the Sn bonds in the tin coupled elastomer, are bonded to diene units of the styrene/diene copolymer, or diene/diene copolymer as the case may be, which might be referred to herein as “Sn-dienyl bonds” (or Si-dienyl bonds), such as, for example, butadienyl bonds in the case of butadiene being terminus with the tin. Creation of tin-dienyl bonds can be accomplished in a number of ways such as, for example, sequential addition of butadiene to the copolymerization system or use of modifiers to alter the styrene and/or butadiene and/or isoprene reactivity ratios for the copolymerization.

The tin coupling of the elastomer can be accomplished by various tin compounds. Tin tetrachloride is usually preferred. The tin coupled copolymer elastomer can also be coupled with an organo tin compound such as, for example, alkyl tin trichloride, dialkyl tin dichloride and trialkyl tin monochloride, yielding variants of a tin coupled copolymer with the trialkyl tin monochloride yielding simply a tin terminated copolymer. Examples of tin modified, or coupled, styrene/butadiene are described in U.S. Pat. No. 5,064,910.

The filler is particularly a hydrophilic filler, most particularly a silica or silicic acid filler, as used in white tire compositions. Alternative reinforcing fillers include carbon black, mineral oxides of aluminous type, in particular alumina (Al2O3) or aluminum (oxide-) hydroxides, or titanium oxide (TiO2), silicates such as aluminosilicates or a natural organic filler such as cellulose fiber or starch, or a mixture of these different fillers. The elastomer composition should preferably contain a sufficient amount of silica, and/or an alternative reinforcing filler such as carbon black, to contribute a reasonably high modulus and high resistance to tear. The combined weight of the silica, alumina, aluminosilicates and/or carbon black in the elastomer composition is generally in the range 10 to 200% by weight based on the elastomer, preferably 30 to 100% by weight based on elastomer. For tire tread compositions the reinforcing filler content is more preferably from about 35 to about 90% by weight based on elastomer.

The reinforcing filler can for example be any commonly employed siliceous filler used in rubber compounding applications might be used as the silica in this invention, including pyrogenic or precipitated siliceous pigments or aluminosilicates. Precipitated silicas are preferred, for example those obtained by the acidification of a soluble silicate, e.g., sodium silicate.

The precipitated silica preferably has a BET surface area, as measured using nitrogen gas, in the range of about 20 to about 600, and more usually in a range of about 40 or 50 to about 300 square meters per gram. The BET method of measuring surface area is described in the Journal of the American Chemical Society, Volume 60, Page 304 (1930). The silica may also be typically characterized by having a dibutylphthalate (DBP) value in a range of about 100 to about 350, and more usually about 150 to about 300 cm3/100 g, measured as described in ASTM D2414.

The silica, and the alumina or aluminosilicate if used, preferably have a CTAB surface area in a range of about 100 to about 220 m2/g (ASTM D3849). The CTAB surface area is the external surface area as evaluated by cetyl trimethylammonium bromide with a pH of 9. The method is described in ASTM D 3849 for set up and evaluation. The CTAB surface area is a well known means for characterization of silica.

Various commercially available silicas may be considered for use in elastomer compositions in conjunction with the coupling agents of this invention such as, only for example herein, and without limitation, silicas commercially available from PPG Industries under the Hi-Sil trademark with designations Hi-Sil EZ150G, 210, 243, etc; silicas available from Rhodia with, for example, designations of Zeosil 1165 MP, 1115 MP, HRS1200 MP, silicas available from Degussa AG with, for example, designations VN3, Ultrasil 7000 and Ultrasil 7005, and silicas commercially available from Huber having, for example, a designation of Hubersil 8745 and Hubersil 8715. Treated precipitated silicas can be used, for example the aluminum-doped silicas described in EP-A-735088.

If alumina is used in the elastomer compositions of the invention, it can for example be natural aluminum oxide or synthetic aluminum oxide (Al₂O₃) prepared by controlled precipitation of aluminum hydroxide. The reinforcing alumina preferably has a BET surface area from 30 to 400 m²/g, more preferably between 60 and 250 m²/g, and an average particle size at most equal to 500 nm, more preferably at most equal to 200 nm. Examples of such reinforcing aluminas are the aluminas Al25, CR125, D65CR from Baïkowski or the neutral, acidic, or basic Al₂O₃ that can be obtained from the Aldrich Chemical Company. Neutral alumina is preferred.

Examples of aluminosilicates which can be used in the elastomer compositions of the invention are Sepiolite, a natural aluminosilicate which might be obtained as PANSIL from Tolsa S.A., Toledo, Spain, and SILTEG, a synthetic aluminosilicate from Degussa GmbH.

Other inorganic fillers may be used. These include reinforcing titanium dioxide as described in EP-A-1114093 or silicon nitride as described in EP-A-1519986.

Examples of natural organic fillers which can be used in the elastomer compositions of the invention is cellulose fibers as described in EP-A-1053213 or starch as described in U.S. Pat. No. 5,672,639, U.S. Pat. No. 6,458,871, US-A-2005/0148699 and U.S. Pat. No. 6,878,760.

The quantity of carbon black in the total reinforcing filler, if present, may vary within wide limits. The quantity of carbon black is preferably less than the quantity of reinforcing inorganic filler present in the elastomer composition. For example, in elastomer compositions for use in tires and tire treads, the carbon black may be present at 0 to 20% by weight based on elastomer, alternatively 2 to 20%, alternatively 0 to 15% and alternatively 5 to 15%.

The sulfidosilane coupling agent of the invention could also be used in a form already “grafted” or “adsorbed” onto the reinforcing filler, it then being possible to bond or treat the filler “pre-coupled” or pre-treated as described for example in U.S. Pat. No. 4,782,040 and U.S. Pat. No. 6,613,2139 in this manner to the diene elastomer by means of the polysulfide function.

The sulfidosilane coupling agent composition of the invention is preferably used at least 0.1% by weight, based on the reinforcing filler. More preferably it is used at 0.5 to 20% by weight, most preferably from 1 or 2 up to 10 or 15% by weight based on the reinforcing filler. The elastomer composition preferably contains 0.2 to 10% by weight of the coupling agent composition of the invention, and may for example contain 0.02 to 10%, preferably 0.1 to 5%, by weight of the sulfidosilane of the formula

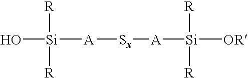

The elastomer composition may contain, in addition to a coupling agent according to the present invention, an agent for covering the reinforcing filler such as an tetraalkoxysilane as tetraethoxysilane or as an alkylalkoxysilane, particularly an alkyltriethoxysilane such as 1-octyltriethoxysilane or 1-hexadecyltriethoxysilane, a polyetherpolyol such as polyethylene glycol, an amine such as a trialkanolamine or a hydroxylated polyorganosiloxane such as a hydroxyl-terminated polydimethylsiloxane. The elastomer composition may also contain, in addition to a coupling agent according to the present invention, a trialkoxy or dialkoxy coupling agent such as a bis(trialkoxysilylpropyl)disulfane or tetrasulfane or a bis(dialkoxymethylsilylpropyl)disulfane or tetrasulfane, although such trialkoxy and dialkoxy coupling agents tend to increase VOC emission compared to the coupling agent according to the present invention.

The elastomer composition can be compounded by methods generally known in the rubber compounding art such as mixing the elastomer(s) with various commonly-used additive materials such as, for example, curing aids, such as sulfur, activators, retarders and accelerators, processing additives, such as oils, resins including tackifying resins, silicas, and plasticizers, fillers, pigments, fatty acid, zinc oxide, waxes, antioxidants and antiozonants, heat stabilizers, UV stabilizers, dyes, pigments, extenders and peptizing agents.

Typical amounts of tackifier resins, if used, comprise about 0.5 to about 10% by weight based on elastomer, preferably 1 to 5%. Typical amounts of processing aids comprise about 1 to about 50% by weight based on elastomer. Such processing aids can include, for example, aromatic, naphthenic, and/or paraffinic processing oils.

Typical amounts of antioxidants comprise about 1 to about 5% by weight based on elastomer. Representative antioxidants may be, for example, diphenyl-p-phenylenediamine and others, for example those disclosed in The Vanderbilt Rubber Handbook (1978), Pages 344 through 346. Typical amounts of antiozonants also comprise about 1 to 5% by weight based on elastomer.

Typical amounts of fatty acids, if used, which can include stearic acid or zinc stearate, comprise about 0.1 to about 3% by weight based on elastomer. Typical amounts of zinc oxide comprise about 0 to about 5% by weight based on elastomer alternatively 0.1 to 5%.

Typical amounts of waxes comprise about 1 to about 5% by weight based on elastomer. Microcrystalline and/or crystalline waxes can be used.

Typical amounts of peptizers comprise about 0.1 to about 1% by weight based on elastomer. Typical peptizers may for example be pentachlorothiophenol or dibenzamidodiphenyl disulfide.

Vulcanization of the elastomer composition is generally conducted in the presence of a sulfur vulcanizing agent. Examples of suitable sulfur vulcanizing agents include, for example, elemental sulfur (free sulfur) or sulfur donating vulcanizing agents, for example, an amine disulfide, polymeric polysulfide or sulfur olefin adducts which are conventionally added in the final, productive, rubber composition mixing step. Preferably, in most cases, the sulfur vulcanizing agent is elemental sulfur. Sulfur vulcanizing agents are added in the productive mixing stage, in an amount ranging from about 0.4 to about 8% by weight based on elastomer, preferably 1.5 to about 3%, particularly 2 to 2.5%.

Accelerators are used to control the time and/or temperature required for vulcanization and to improve the properties of the vulcanized elastomer composition. In one embodiment, a single accelerator system may be used, i.e., primary accelerator.

Conventionally and preferably, a primary accelerator(s) is used in total amounts ranging from about 0.5 to about 4% by weight based on elastomer, preferably about 0.8 to about 1.5%. In another embodiment, combinations of a primary and a secondary accelerator might be used with the secondary accelerator being used in smaller amounts of about 0.05 to about 3% in order to activate and to improve the properties of the vulcanizate. Delayed action accelerators may be used which are not affected by normal processing temperatures but produce a satisfactory cure at ordinary vulcanization temperatures. Vulcanization retarders can also be used. Suitable types of accelerators that may be used in the present invention are amines, disulfides, guanidines, thioureas, thiazoles, for example mercaptobenzthiazole, thiurams, sulfenamides, dithiocarbamates, thiocarbonates, and xanthates. Preferably, the primary accelerator is a sulfenamide. If a second accelerator is used, the secondary accelerator is preferably a guanidine, dithiocarbamate or thiuram compound.

The compositions are produced in suitable mixers, using two successive preparation phases well-known to the person skilled in the art: a first phase of thermomechanical working or kneading (sometimes referred to as “non-productive” phase) at high temperature, up to a maximum temperature (Tₘₐₓ) of between 110° C. and 190° C., preferably between 130° C. and 180° C., followed by a second phase of mechanical working (sometimes referred to as “productive” phase) at lower temperature, typically less than 110° C., for example between 40° C. and 100° C., during which productive phase the cross-linking or vulcanization system is incorporated.

In the process for manufacturing elastomer compositions according to the invention, at least the reinforcing filler and the coupling agent of the invention are incorporated by kneading into the elastomer during the non-productive, phase, that is to say that at least these different base constituents are introduced into the mixer in any non productive step and are kneaded thermomechanically, in one or more steps, until a maximum temperature of between 110 and 190° C., preferably between 130 and 180° C., is reached.

By way of example, the first (non-productive) phase is effected in a single thermomechanical step during which in a first phase the reinforcing filler and the coupling agent and the elastomer are mixed in a suitable mixer, such as a conventional internal mixer or extruder, then in a second phase, for example after one to two minutes' kneading, any complementary covering agents or processing agents and other various additives, with the exception of the vulcanization system, are introduced into the mixer. When the apparent density of the reinforcing inorganic filler is low (generally the case of silicas), it may be advantageous to divide the introduction thereof into two or more parts. A second step of thermomechanical working may be added in this internal mixer, after the mixture has dropped and after intermediate cooling to a temperature preferably less than 100° C., with the aim of making the compositions undergo complementary thermomechanical treatment, in particular in order to improve further the dispersion, in the elastomeric matrix, of the reinforcing inorganic filler and its coupling agent. The total duration of the kneading, in this non-productive phase, is preferably between 2 and 10 minutes.

After cooling of the mixture thus obtained, the vulcanization system is then incorporated at low temperature, typically on an external mixer such as an open mill, or alternatively on an internal mixer (Banbury type). The entire mixture is then mixed (productive phase) for several minutes, for example between 2 and 10 minutes.

The final composition thus obtained is then calendared, for example in the form of thin slabs (thickness of 2 to 3 mm) or thin sheets of rubber in order to measure its physical or mechanical properties, in particular for laboratory characterization, or alternatively extruded to form rubber profiled elements used directly, after cutting or assembling to the desired dimensions, as a semi-finished product for tires, in particular as treads, plies of carcass reinforcements, sidewalls, plies of radial carcass reinforcements, beads or chaffers, inner tubes or air light internal rubbers for tubeless tires.

The vulcanization (or curing) of the tire or tread is carried out in known manner at a temperature of preferably between 130 and 200° C., under pressure, for a sufficient time. The required time for vulcanization may vary for example between 5 and 90 min as a function in particular of the curing temperature, the vulcanization system adopted and the vulcanization kinetics of the composition in question.

The sulfidosilane coupling agent of the formula

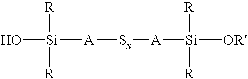

as defined above contains less ethoxy substituents than the corresponding bis(dimethylethoxysilylpropyl)oligosulfanes described in EP-A-1043357, leading to less ethanol emission during rubber compounding. The sulfidosilanes of the formula

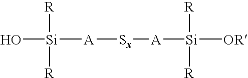

and the coupling agent compositions containing them, exhibit an unexpected stability against condensation of the silanol groups therein to form disiloxane dimers. They are thus similarly effective as coupling agents to the bis(dimethylethoxysilylpropyl)oligosulfanes.

The invention is illustrated by the following Example, in which parts and percentages are by weight

### Example 1

83.5 kg of a 45% aqueous solution of sodium hydrosulfide NaSH was charged to a 400 gallon (about 1800 liter) reactor followed by 19.5 kg water. Agitation was started and 48 kg 50% aqueous caustic soda NaOH was added followed by 19 kg water. 56 kg sulfur was added and the reactor was heated to 75° C. and held at this temperature for an hour.

4.5 kg tetrabutylammonium bromide was added. 216 kg chloropropyldimethylethoxysilane was charged to the reactor over one hour while holding the reactor temperature at 75° C., and the reactor was maintained at this temperature for a further 2 hours, then at 90° C. for 2 hours. The agitator of the vessel was kept on throughout the reaction, resulting in vigorous agitation as the reactor was only about one quarter full. The reactor was cooled to 55° C. and 83 kg water was added. Agitation was stopped and the reaction mixture was allowed to settle for 30 minutes.

The lower aqueous layer was removed. The remaining organic (silane) layer was vacuum stripped for 1 hour at 100° C. and for a further hour at 100° C. with nitrogen sparge.

The product was a sulfidosilane mixture suitable for use as a coupling agent. Analysis of the prepared batch demonstrated that it contained about 22% of the novel (hydroxydimethylsilylpropyl)(ethoxydimethylsilylpropyl)tetrasulfane of the formula

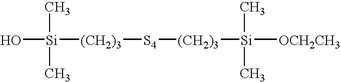

together with about 77% of the symmetric bis(ethoxydimethylsilylpropyl)tetrasulfane and about 1% of bis(hydroxydimethylsilylpropyl)tetrasulfane.

The product prepared was used as a coupling agent in silica filled rubber compositions. Table 1 shows the formulation of the three compositions (amounts of the different products expressed in phr).

TABLE 1

| | | | |
|---|---|---|---|
| | CONTROL A | CONTROL B | SAMPLE C |
| ingredients | phr | phr | phr |

NON PRODUCTIVE 1

| | | | |
|---|---|---|---|
| SBR (1) | 70 | 70 | 70 |
| BR (2) | 30 | 30 | 30 |
| Oil (3) | 30 | 30 | 30 |
| silica (4) | 80 | 80 | 80 |
| TESPT (5) | 6.4 | 0 | 0 |
| MESPT (6) | 0 | 5 | 0 |
| Silane from Example 1 | 0 | 0 | 4.9 |
| Stearic acid | 2 | 2 | 2 |

NON PRODUCTIVE 2

| | | | |
|---|---|---|---|
| ZnO | 2.5 | 2.5 | 2.5 |

PRODUCTIVE

| | | | |
|---|---|---|---|
| DPG (7) | 1.5 | 1.5 | 1.5 |
| 6-PPD (8) | 1.9 | 1.9 | 1.9 |
| S | 1.1 | 1.1 | 1.1 |
| CBS (9) | 2 | 2 | 2 |

(1) SSBR BUNA@VSL 5025-0 from Lanxess
(2) BUNA@CB 24 from Lanxess
(3) Processing oil Nytex 832 from Nynas
(4) Silica type “HD” - Zeosil 1165MP from Rhodia
(5) TESPT - bis(triethoxysilylpropyl)tetrasulfane
(6) MESPT - bis(monoethoxydimethylsilylpropyl)tetrasulfane
(7) Diphenylguanidine
(8) N-1,3-dimethylbutyl-N-phenyl-para-phenylenediamine (“Santoflex 6-PPD” from Flexys)
(9) N-cyclohexyl-2-benzothiazyl sulfonamide (“Santocure CBS” from Flexys)

These compositions are identical except for the coupling agent used.

The rubber compositions were prepared as follows: The diene elastomer (or the mixture of diene elastomers), the reinforcing filler, the coupling agent, then the various other ingredients, with exception of the vulcanization system, are introduced into an internal mixer filled to 70%. The initial tank temperature is 80° C. Thermomechanical working (non productive phase) is then performed in two stages until a maximum dropping temperature of about 160° C. is reached. Between the two steps, the mixtures are cooled to a temperature of 23° C. The samples are then blended with the curing system (productive mixing) in an internal rubber mixer for about 3 minutes. The compositions thus obtained are calendared in the form of sheets of 2 to 3 mm before curing and molding at 15 minutes at 160° C. The rubber compositions were characterized before and after curing as indicated below:

### Rheometry

The measurements are performed at 160° C. using an oscillating chamber rheometer in accordance with Standard ISO 3417:1991(F). The change in rheometric torque over time describes the course of stiffening of the composition as a result of the vulcanization reaction. The measurements are processed in accordance with Standard ISO 3417:1991(F), minimum and maximum torque values, measured in deciNewton.meter (dN.m) are respectively denoted S′@min and S′@max; t i is the induction time, i.e. the time required for the vulcanization reaction to begin; t a (for example t 10%) is the time necessary to achieve conversion of a %, i.e. a % (for example 10%) of the difference between the minimum and maximum torque values. The difference, denoted S′ max−S′ min (in dN.m), between minimum and maximum torque values is also measured, as is the maximum cure rate denoted maximum S′ rate (in dN.m/min), which allows an assessment of vulcanization kinetics to be made. In the same conditions the scorching time for the rubber compositions at 160° C. is determined by the parameter Ts2, expressed in minutes, and defined as being the time necessary to obtain an increase in the torque of 2 units, above the minimum value of the torque.

### Tensile Tests

These tests make it possible to determine elasticity stresses and breaking properties. They are performed in accordance with ISO Standard IS037:1994(F). The nominal stress (or apparent stresses, in MPa) at 10% elongation (S10), 100% elongation (S100) and 300% elongation (S300) are measured at 10%, 100% and 300% of elongation. Breaking stresses (in MPa) and elongations at break (in %) are also measured. All these tensile measurements are performed under normal conditions of temperature and relative humidity in accordance with ISO Standard ISO 471.

### Dynamic Properties

Dynamic properties are measured on a viscoanalyser (Metravib VA4000), in accordance with ASTM Standard D5992-96. The response of a sample of vulcanized composition (thickness of 2.5 mm and a cross-section of 40 mm²), subjected to an alternating single sinusoidal shearing stress, at a frequency of 10 Hz, under a controlled temperature of 50° C. is recorded. Scanning is performed at amplitude of deformation of 0.1 to 50% the maximum observed value of the loss factor tan(δ) is recorded, the value being denoted tan(δ) max.

### Ethanol Emission

The ethanol contents are measured by Multiple Headspace Extraction (Headspace 7694 from Agilent Technologies) with GC-FID analysis. Sample to analyze is prepared 1 minute after the end of mixing corresponding to the non-productive steps (ETHANOL NP1) and 1 minute after the end of the curing (ETHANOL NP2). Nearly 1 g of the blend is weighed and introduced in a headspace bottle witch is immediately closed. After a calibration, the ethanol content of each sample is measured.

The results of the tests are shown in Table 2 below.

TABLE 2

| | | |
|---|---|---|
| CON- | CON- | SAMPLE |
| TROL A | TROL B | C |

curing

| | | | | |
|---|---|---|---|---|
| S′@Min S′(ML) | d · Nm | 1.59 | 1.62 | 1.53 |
| S′@Max S′(MH) | d · Nm | 10.88 | 15.11 | 15.19 |
| S′Max − S′min | d · Nm | 9.29 | 13.49 | 13.66 |
| Time@10% cure S′ | min | 4.39 | 4.88 | 4.79 |
| Time@50% cure S′ | min | 7.87 | 6.41 | 6.43 |
| Time@90% cure S′ | min | 15.16 | 11.03 | 12 |
| maximum S′ rate | d · Nm/min | 1.7 | 4.6 | 5.3 |
| Time@2 dNm scorch | min | 5.86 | 5.29 | 5.23 |
| S′ | | | | |

Tensile

| | | | | |
|---|---|---|---|---|
| S10 | MPa | 0.30 | 0.42 | 0.42 |
| S100 | MPa | 1.68 | 2.54 | 2.64 |
| S300 | MPa | 9.99 | 13.68 | 13.89 |
| tan max | | 0.126 | 0.127 | 0.127 |
| Tensile break MPa | MPa | 16.22 | 17.52 | 16.77 |
| Elong max % | % | 406.48 | 366.78 | 348.02 |
| ETHANOL NP1 | % | 0.655 | 0.1 | 0.055 |
| ETHANOL NP2 | % | 0.3 | 0.035 | 0.02 |
| CURED SAMPLES | % | 0.295 | 0.035 | 0.035 |

Examination of the various results of Table 2 gives rise to the following observations:
the sample C comprising the new product exhibits a shorter scorching time than that of the controls A, but this time Ts2 is sufficient to provide a satisfactory safety margin with regard to the problem of scorching;
after curing, sample C, in comparison with the control B composition, exhibits modulus values at high deformation (S100 and S300) which are very close, and much higher than control A, these both being clear indicators to the person skilled in the art of the quality of coupling provided by the new product;
sample C, in comparison with the control compositions A and B, exhibits hysteresis properties (tan δmax) which are very close, these being clear indicators to the person skilled in the art of the quality of coverage and dispersion of the coupling provided by the new product.

Moreover, the sample C is unexpectedly distinguished by curing kinetic (maximum S′ rate) which is more than three times as high as that of the control A and improved about 15% compared to control B; in other words, curing of the composition containing the new product may be performed in a distinctly shorter time.

Replacing a polysulfurised alkoxysilane such as TESPT with the product of the invention also constitutes a considerable advantage with regard to the environment and the problem caused by emissions of VOC (“volatile organic compounds”). As depicted in table 2, the sample C has reduced ethanol content after the non productive phase 1 and 2, and after curing. After the non productive phase, the ethanol content of sample C is more than 15 times lower than that of the control A and about 3 times lower than that of control B. Moreover, the ethanol content of cured compositions is decreased from 0.295% for the control A to 0.035% for sample C. In other words, compared to compositions containing TESPT, the cured composition containing the new product may emit a much reduced amount of Volatile Organic Compounds during the different phases of the manufacture of the rubber compositions and also during the lifetime after curing and molding.

In summary, the overall behavior of composition containing the new product of the invention not only reflects a high quality bond (or coupling) between the reinforcing inorganic filler and the diene elastomer, which is at least equal to that available with the MESPT but clearly improved to that of conventional alkoxysilane polysulfides such as TESPT, but also, unexpectedly, very distinctly improved vulcanizability. Moreover, compared to compositions containing TESPT, the composition containing the new product may emit a much reduced amount of Volatile Organic Compounds during the different phases of the manufacture of the rubber compositions and also during the lifetime after curing and molding.

1. A process for the preparation of a sulfidosilane of the formula 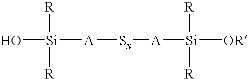
wherein each R, which may be the same or different, represents an alkyl or aryl group having 1 to 18 carbon atoms, R′ represents an alkyl, hydroxyalkyl, or alkoxyalkyl group having 1 to 8 carbon atoms, each A independently represents the same or different divalent organic group having 1 to 18 carbon atoms and x has a value in the range 2 to 10, the process comprising: hydrolyzing a bis(dialkylalkoxysilyl)sulfidosilane under alkaline conditions, wherein the bis(dialkylalkoxysilyl)sulfidosilane is of the formula 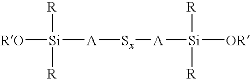
wherein each R, which may be the same or different, represents an alkyl or aryl group having 1 to 18 carbon atoms, each R′ represents an alkyl, hydroxyalkyl, or alkoxyalkyl group having 1 to 8 carbon atoms, each A independently represents the same or different divalent organic group having 1 to 18 carbon atoms and x has an average value in the range 2 to 5.

2. A process for the preparation of a sulfidosilane of the formula 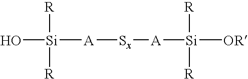
wherein each R, which may be the same or different, represents an alkyl or aryl group having 1 to 18 carbon atoms, R′ represents an alkyl, hydroxyalkyl, or alkoxyalkyl group having 1 to 8 carbon atoms, each A independently represents the same or different divalent organic group having 1 to 18 carbon atoms and x has a value in the range 2 to 10, wherein a bis(dialkylalkoxysilyl)sulfidosilane of the formula 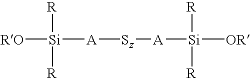
wherein each R, which may be the same or different, represents an alkyl or aryl group having 1 to 18 carbon atoms, each R′ represents an alkyl, hydroxyalkyl, or alkoxyalkyl group having 1 to 8 carbon atoms, each A represents a divalent organic group having 1 to 18 carbon atoms and z has a value in the range 2 to 10, is reacted in the presence of a base with a hydroxydialkylmercaptosilane of the formula (HO)R₂Si-A-SH, where each R is selected from alkyl or aryl groups having 1 to 18 carbon atoms, and A represents a divalent organic group having 1 to 18 carbon atoms.

3. A process for the preparation of a sulfidosilane of the formula 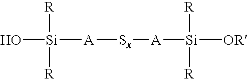
wherein each R which may be the same or different, represents an alkyl or aryl group having 1 to 18 carbon atoms, R′ represents an alkyl, hydroxyalkyl, or alkoxyalkyl group having 1 to 8 carbon atoms, each A independently represents the same or different divalent organic group having 1 to 18 carbon atoms and x has a value in the range 2 to 10, wherein a bis(dialkylhydroxysilyl)sulfidosilane of the formula 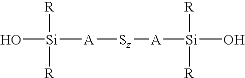
wherein each R which may be the same or different, represents an alkyl or aryl group having 1 to 18 carbon atoms, each A independently represents the same or different divalent organic group having 1 to 18 carbon atoms and z has a value in the range 2 to 10, is reacted in the presence of a base with an alkoxydialkylmercaptosilane of the formula (R′O)R₂Si-A —SH, where each R is selected from alkyl or aryl groups having 1 to 18 carbon atoms and each R′ represents an alkyl, hydroxyalkyl, or alkoxyalkyl group having 1 to 8 carbon atoms, and A represents a divalent organic group having 1 to 18 carbon atoms.

4. An elastomer composition comprising at least one diene elastomer, at least one reinforcing filler and a sulfidosilane coupling agent composition, wherein the sulfidosilane coupling agent composition comprises a sulfidosilane of the formula 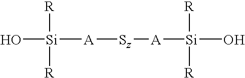
wherein each R which may be the same or different, represents an alkyl or aryl group having 1 to 18 carbon atoms, each A independently represents the same or different divalent organic group having 1 to 18 carbon atoms and z has a value in the range 2 to 10.

5. An elastomer composition according to claim 4 containing 0.1 to 10% by weight of the sulfidosilane.

6. An elastomer composition according to claim 4 or 5, characterized in that the sulfidosilane coupling agent composition also comprises at least one sulfidosilane of the formula
(R′O)R₂Si-A-Sₓ-A SiR₂(OR′)
wherein each R is selected from alkyl or aryl groups having 1 to 18 carbon atoms, each R′ is selected from alkyl, hydroxyalkyl, or alkoxyalkyl groups having 1 to 8 carbon atoms, each A independently represents the same or different divalent organic group having 1 to 18 carbon atoms and x has an average value in the range 2 to 5.
